(19) United States
(12) Patent Application Publication
(10) Pub. No.: US 2012/0226618 A1
(43) Pub. Date: Sep. 6, 2012

(54) PROJECT MANAGEMENT SYSTEM

(76) Inventor: Steeve Teong Sin KAY, Irvine, CA (US)

(21) Appl. No.: 13/409,078

(22) Filed: Feb. 29, 2012

Related U.S. Application Data
(63) Continuation-in-part of application No. 13/189,374, filed on Jul. 22, 2011.
Application No. 13/189,374 is a continuation-in-part of application No. 13/038,281, filed on Mar. 1, 2011.

(51) Int. Cl. G06Q 10/06

(52) U.S. Cl. 705/301

(57) ABSTRACT

A project management system is described, including (i) a people database storing profiles of individuals; (ii) a project processor configured to: display a project template on a graphical user interface for an initial project; enter parameter values into fields of the project template based on inputs from a user; identify individuals to work on the initial project by comparing the profiles of the individuals stored in the people database with the parameter values in the project template; modify the performance evaluation of an individual based on feedback from at least one of realized outcomes; modify at least one of the expected outcomes based on feedback from at least one of the profiles; modify at least one of the expected outcomes based on feedback from at least one of the realized outcomes; and display at least one of the parameter values entered into the project template on the graphical user interface.

### RELATED APPLICATION

This application is a continuation-in-part of U.S. application Ser. No. 13/189,374, entitled “Project Management System and Template,” filed on Jul. 22, 2011, which is a continuation-in-part of U.S. application Ser. No. 13/038,281, entitled “Project Management System,” filed on Mar. 1, 2011, which are hereby incorporated by reference in their entirety.

### FIELD

The subject technology relates to project management systems.

### BACKGROUND

Managing a project can be very time consuming and inefficient, especially as the complexity of projects increase. For example, managing a project may involve determining and acquiring resources (e.g., workers, materials, and/or equipment) needed to complete the project, scheduling the project, making sure that various tasks are completed on schedule, and keeping the project on budget.

### SUMMARY

In one aspect, a project management system comprising a people database, a project database, and a project processor is disclosed. The people database stores profiles of individuals, wherein the profile for each individual comprises indicators for an employment history of the individual, a work position held by the individual, a labor rate of the individual, a type of work performed by the individual, a skill level of the individual, an evaluation of performance by the individual on any project, or portion thereof, completed by the individual, and an availability of the individual for a project. The project database stores information about projects, wherein the information for each project comprises indicators for information on persons needed to complete the project, wherein the information on each person includes at least one of a type of work to be performed by the person, a required skill level of the person, and an amount of time for the person to perform on the project. The information for each project further comprises indicators for expected outcomes of the project, realized outcomes of the project, after they are realized, and a cost of at least a portion of the project. The project processor is configured to identify individuals to work on a project by comparing the profiles of the individuals stored in the people database with the information for the project stored in the project database. The project processor is further configured to modify the performance evaluation based on feedback from at least one of the realized outcomes in relation to at least one of the expected outcomes, modify at least one of the expected outcomes based on feedback from at least one of the profiles, and modify at least one of the expected outcomes based on feedback from at least one of the realized outcomes.

The subject technology is illustrated, for example, according to various aspects described below. Various examples of aspects of the subject technology are described as numbered clauses (1, 2, 3, etc.) for convenience. These are provided as examples, and do not limit the subject technology. It is noted that any of the dependent clauses may be combined in any combination, and placed into a respective independent clause, e.g., clause______. The other clauses can be presented in a similar manner.

1. A project management system comprising:
(i) a people database storing profiles of individuals, wherein the profile for each individual comprises indicators for:
an employment history of the individual;
a work position held by the individual;
a type of work performed by the individual;
a skill level of the individual;
an evaluation of performance by the individual on any project, or portion thereof, completed by the individual; and
an availability of the individual for a project;
(ii) a project database storing information about projects, wherein the information for each project comprises indicators for:
(a) information on persons needed to complete the project, wherein the information on each person includes at least one of:
a type of work to be performed by the person;
a required skill level of the person; and
an amount of time for the person to perform on the project;
(b) expected outcomes of the project;
(c) realized outcomes of the project, after they are realized; and
(d) a cost of at least a portion of the project;
(iii) a project processor configured to:
identify individuals to work on a project by comparing the profiles of the individuals stored in the people database with the information for the project stored in the project database;
modify the performance evaluation based on feedback from at least one of the realized outcomes in relation to at least one of the expected outcomes;
modify at least one of the expected outcomes based on feedback from at least one of the profiles; and
modify at least one of the expected outcomes based on feedback from at least one of the realized outcomes.
2. The system of Clause 1, further comprising a knowledge database having:
(a) first rules that determine how the feedback from the at least one of the realized outcomes in relation to the at least one of the expected outcomes modifies the performance evaluation;
(b) second rules that determine how the feedback from the at least one of the profiles modifies the at least one of the expected outcomes; and
(c) third rules that determine how the feedback from the at least one of the realized outcomes modifies the at least one of the expected outcomes.
3. The system of Clause 2, wherein feedback based on at least one of the realized outcomes modifies at least one of the first rules, the second rules, and the third rules.
4. The system of Clause 2, wherein feedback based on a relation between at least one of the realized outcomes and at least one of the expected outcomes modifies at least one of the first rules, the second rules, and the third rules.
5. The system of Clause 1, wherein at least one of the expected outcomes comprises a cost of at least a portion of the project.
6. The system of Clause 1, wherein at least one of the expected outcomes comprises a time to completion of at least a portion of the project.
7. The system of Clause 2, wherein the at least one of the realized outcomes comprises an actual time to completion of a portion of a project and the at least one of the expected outcomes comprises an expected time to completion of the portion of the project.
8. The system of Clause 7, wherein the first rules comprises a performance rule that increases a performance evaluation value of an individual when the actual time to completion occurs before the expected time to completion, and decreases the performance evaluation value of the individual when the actual time to completion occurs after the expected time to completion.
9. The system of Clause 8, wherein the performance rule is modified based on at least one of the realized outcomes comprising at least one of an environmental and an economic condition that negatively impacts an ability of the individual to complete the portion of the task.
10. The system of Clause 9, wherein the project processor is configured to automatically track the at least of the environmental and the economic condition.
11. The system of Clause 2, wherein the at least one of the realized outcomes comprises an actual cost to complete a portion of a project and the at least one of the expected outcomes comprises an expected cost to complete the portion of the project.
12. The system of Clause 11, wherein the first rules comprise a performance rule that increases a performance evaluation value of an individual when the actual cost is below the expected cost, and decreases the performance evaluation value of the individual when the actual cost exceeds the expected cost.
13. The system of Clause 12, wherein the performance rule is modified based on at least one of the realized outcomes comprising an environmental or economic condition that negatively impacts an ability of the individual to complete the portion of the task.
14. The system of Clause 13, wherein the project processor is configured to automatically track the environmental or economic condition.
15. The system of Clause 2, wherein the second rules comprise an expected outcome rule that increases an expected time to completion or an expected cost of a portion of a project when a performance evaluation value of an individual is decreased.
16. The system of Clause 2, wherein the third rules comprise an expected outcome rule that increases an expected time to completion of a task of a project when a realized time to completion of a previous task of the project exceeds an expected time to completion of the previous task.
17. The system of Clause 1, wherein the profile for each individual further comprises indicators for at least one professional parameter and indicators for at least one character parameter.
18. The system of Clause 1, wherein the information for each project further comprises indicators for at least one professional criterion and indicators for at least one character criterion.
19. A method of managing a project in a project management system, the project management system comprising (i) a people database storing profiles of individuals, wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project, and (ii) a project database storing information about projects, wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project, the method comprising:
identifying individuals to work on a project by comparing the profiles of the individuals stored in the people database with the information for the project stored in the project database;
modifying a performance evaluation based on feedback from at least one of the realized outcomes in relation to at least one of the expected outcomes;
modifying at least one of the expected outcomes based on feedback from at least one of the profiles; and
modifying at least one of the expected outcomes based on feedback from at least one of the realized outcomes.
20. The method of Clause 19, further comprising:
displaying a project template on a graphical user interface for the first project;
entering parameter values into fields of the project template based on inputs from a user, the parameter values including:
(a) information on at least one person needed to complete the first project;
(b) expected outcomes of the first project; and
(c) a cost of at least a portion of the first project; and displaying at least one of the parameter values entered into the project template on the graphical user interface for a subsequent project.
21. The method of Clause 19, wherein identifying individuals to work on a project is performed by comparing at least one professional parameter of the individuals stored in the people database with at least one professional criterion for the project stored in the project database.
22. The method of Clause 19, wherein identifying individuals to work on a project is performed by comparing at least one character parameter of the individuals stored in the people database with at least one character criterion for the project stored in the project database.
23. The method of Clause 19, further comprising:
(a) modifying, by a processor, the performance evaluation based on first rules and the feedback from the at least one of the realized outcomes in relation to the at least one of the expected outcomes;
(b) modifying, by a processor, the at least one of the expected outcomes based on second rules and the feedback from the at least one of the profiles; and
(c) modifying, by a processor, the at least one of the expected outcomes based on third rules and the feedback from the at least one of the realized outcomes.
24. A method of managing a project in a project management system, comprising:
identifying, by a processor, individuals to work on a project by comparing profiles of individuals stored in a people database with information for projects stored in a project database; wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project;
modifying, by a processor, a performance evaluation based on feedback from at least one of the realized outcomes in relation to at least one of the expected outcomes;
modifying, by a processor, at least one of the expected outcomes based on feedback from at least one of the profiles; and
modifying, by a processor, at least one of the expected outcomes based on feedback from at least one of the realized outcomes;
wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project.
25. The method of Clause 24, further comprising:
displaying a project template on a graphical user interface for the first project;
entering parameter values into fields of the project template based on inputs from a user, the parameter values including:
(a) information on at least one person needed to complete the first project;
(b) expected outcomes of the first project; and
(c) a cost of at least a portion of the first project; and
displaying at least one of the parameter values entered into the project template on the graphical user interface for a subsequent project.
26. The method of Clause 24, wherein identifying individuals to work on a project is performed by comparing at least one professional parameter of the individuals stored in the people database with at least one professional criterion for the project stored in the project database.
27. The method of Clause 24, wherein identifying individuals to work on a project is performed by comparing at least one character parameter of the individuals stored in the people database with at least one character criterion for the project stored in the project database.
28. The method of Clause 24, further comprising:
(a) modifying, by a processor, the performance evaluation based on first rules and the feedback from the at least one of the realized outcomes in relation to the at least one of the expected outcomes;
(b) modifying, by a processor, the at least one of the expected outcomes based on second rules and the feedback from the at least one of the profiles; and
(c) modifying, by a processor, the at least one of the expected outcomes based on third rules and the feedback from the at least one of the realized outcomes.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

FIG. 1 shows a block diagram of a project management system according to some embodiments of the subject technology.

FIG. 2 shows a flowchart of a method for managing a project according to some embodiments of the subject technology.

FIG. 3 shows a flowchart of a method for managing a project according to some embodiments of the subject technology.

FIG. 4 shows a flowchart of a method for modifying a profile based on feedback according to some embodiments of the subject technology.

FIG. 5 shows a schematic illustration of a data structure according to some embodiments of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as “an aspect” may refer to one or more aspects and vice versa. A phrase such as “an embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such “an embodiment” may refer to one or more embodiments and vice versa. A phrase such as “a configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as “a configuration” may refer to one or more configurations and vice versa.

As used herein, the phrase “at least one” of preceding a series of categories of criteria, with the term “and” to separate the categories of criteria, modifies the list as a whole, rather than each member of the list (i.e., each category in the list). The phrase “at least one” of does not require selection of at least one value for each category; rather, the phrase allows a meaning that includes at least one value of only one category. By way of example, the phrase “at least one of A, B, and C” includes only A. The phrase “at least one of A, B, and C” includes only A and B. The phrase “at least one of A, B, and C” includes A, B, and C. The phrase “at least one of A, B, and C” includes a plurality of only A.

The description of the subject technology is provided to enable any person skilled in the art to practice the various embodiments described herein. While the subject technology has been particularly described with reference to the various figures and embodiments, it should be understood that these are for illustration purposes only and should not be taken as limiting the scope of the invention.

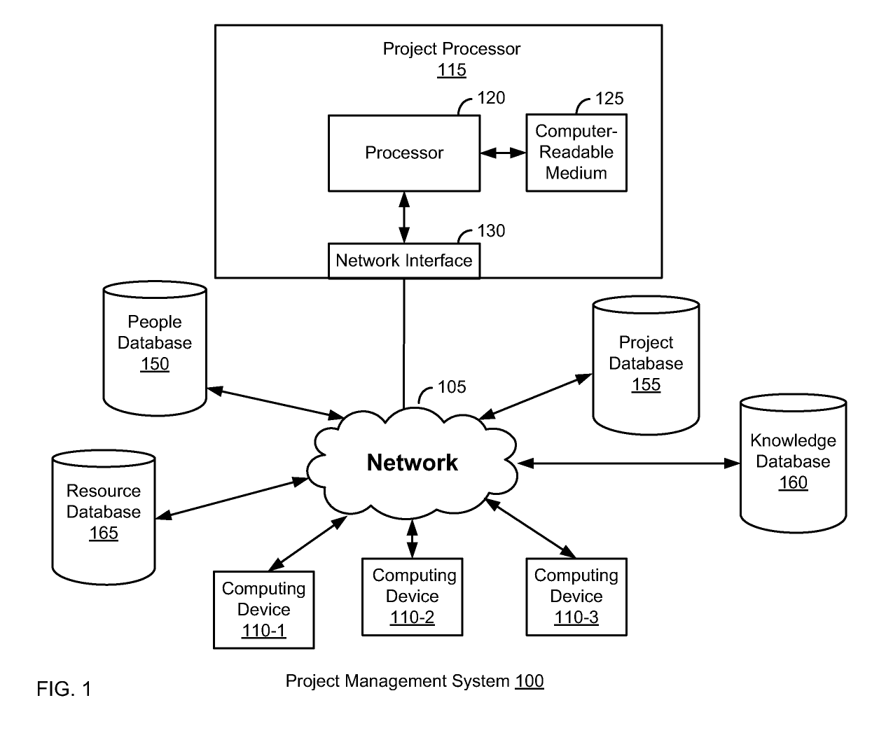

FIG. 1 shows a project management system 100 according to some embodiments of the subject technology. The project management system 100 may comprise a plurality of computing devices 110-1, 110-2, and 110-3, a people database 150, a project database 155, a knowledge database 160, a resource database 165, and a project processor 115. The various components of the system 100 may communicate with one another over a network 105. The computing devices 110-1 to 110-3 may include desktops, laptops, smart phones, hand-held devices, mobile telecommunications devices, and other computing devices capable of communicating with any one of the databases 150, 155, 160, and 165 and/or the project processor 115 over the network 105. The network 105 may include the Internet, a cellular network, a Public Switch Telephone Network (PSTN), a local area network (LAN), or a combination thereof. The network 105 may include intermediary systems, such as networking equipment, social network platforms, third-party servers, etc., configured to connect the computing devices 110-1 to 110-3 with the project processor 115. Intermediary systems may be provide a connection for computing devices 110-1 to 110-3 to provide an input to or receive an output from the project processor 115. Although the example in FIG. 1 shows the databases 150, 155, 160, and 165 communicating with the project processor 115 over the network 105, one skilled in the art will appreciate that one or more of the databases 150, 155, 160, and 165 may be directly coupled to the project processor 115 via a bus and/or a wireless link.

The project processor 115 performs various project management operations described herein. The project processor 115 may include a network interface 130, one or more processors 120, and computer-readable medium 125. The network interface 130 interfaces the processor 120 to the network 105. The computer-readable medium 125 may be used to store data temporarily that is retrieved from the databases 150, 155, 160, and 165 and is being processed by the processor 120. The computer-readable medium 125 may also store one or more programs that are executed by the processor 120 to perform the various functions of the project processor 115 discussed below.

According to some embodiments, the people database 150 is used to store profiles of individuals. The profile for each individual may include information relating to professional parameters or character parameters.

As used herein, “professional parameters” means information with respect to an individual's ability and availability to perform a discrete project task. Character parameters refer to a “state of doing” of an individual. Professional parameters may be qualitative or quantitative. Professional parameters may be based on one or more objective criteria or one or more subjective criteria. Professional parameters may include an employment history of the individual, a work position held by the individual, a type of work performed by the individual, labor rate of the individual, a skill level of the individual, an evaluation of performance by the individual on any project, or portion thereof, completed by the individual, and an availability of the individual for a project. Information for each individual may be entered into the profile for the individual in the people database 150 via one of the computing devices 110-1 to 110-3 and/or the project processor 115, as discussed further below.

As used herein, “character parameters” means information with respect to an individual's likelihood to take a certain course of action affecting other individuals or the manner in which a discrete project task is performed. Character parameters refer to a “state of being” of an individual. Character parameters may be qualitative or quantitative. Character parameters may be based on one or more objective criteria or one or more subjective criteria. Character parameters may include reputation, trustworthiness, reliability, personality traits, emotional intelligence, social adaptability, and the like. Character parameters for each individual may be entered into the profile based on data gathered from character sources, such as peer evaluations, supervisor evaluations, customer or client evaluations, criminal records, credit reports, public or community service experience, personal references, personality evaluations, psychological evaluations, and the like. Character parameters may be quantitative or qualitative. Character parameters may be recorded, quantified, categorized, ranked, subject to a threshold, or otherwise made available for further analysis. Character parameters may be retrieved from or based on information stored on public or semi-public records, including government records or social networking databases. For example, activities, postings, and available information on a social networking platform with respect to an individual may contribute or define a character parameter.

According to some embodiments, the project database 155 is used to store information about projects. The information for each project may include information regarding required or preferred resources (e.g., persons, materials, tools, or equipment), information regarding the methods for carrying out or completing the project, and information regarding the output for a project (e.g., desired outcomes, expected outcomes, or realized outcomes). The information for each project may include information on persons needed to complete the project, wherein the information on each person includes at least one of a professional criterion and a character criterion. As used herein, “professional criterion” means a requirement for, threshold of, or basis for comparison to a corresponding professional parameter. For example, a professional criterion may include type of work to be performed by the person, a required skill level of the person, and an amount of time for the person to perform on the project. As used herein, “character criterion” means a requirement for, threshold of, or basis for comparison to a corresponding character parameter. For example, a character criterion may include a level of reputation, trustworthiness, reliability, social adaptability, emotional intelligence, or set of personality traits. The information for each project may also include expected outcomes of the project, and realized outcomes of the project, after they are realized. Information about each project may be inputted to the project database 155 via one of the computing devices 110-1 to 110-3 and/or the project processor 115, as discussed further below.

According to some embodiments, the project processor 115 is configured to identify individuals to work on a project by comparing the profiles of the individuals stored in the people database 150 with the information about the project stored in the project database 155. The project processor 115 may be further configured to modify the performance evaluation for an individual based on feedback from at least one of the realized outcomes in relation to at least one of the expected outcomes, to modify at least one of the expected outcomes based on feedback from at least one of the profiles, and/or to modify at least one of the expected outcomes based on feedback from at least one of the realized outcomes. As used herein, “feedback” means a return of at least a portion of an output of a process or system to an input, including anything used in whole or in part from an output to influence or affect at least a portion of an input.

According to some embodiments, the knowledge database 160 is used to store rules that direct the project processor 115 how to modify information in the databases 150, 155, 160, and 165 based on feedback. For example, the knowledge database 160 may include first rules that determine how the feedback from the at least one of the realized outcomes in relation to the at least one of the expected outcomes modifies the performance evaluation for an individual, second rules that determine how the feedback from the at least one of the profiles modifies the at least one of the expected outcomes, and/or third rules that determine how the feedback from the at least one of the realized outcomes modifies the at least one of the expected outcomes.

According to some embodiments, the expected outcomes or the realized outcomes are based on one or more objective criteria or one or more subjective criteria. By further example, the expected outcomes and the realized outcomes are evaluated for one or more of (1) quality, (2) satisfaction, (3) time, and (4) cost. For example, the expected outcomes and the realized outcomes are compared to a quality threshold or applied to a quality rating. Such thresholds or ratings may include or be based on industry standards, quality assurance requirements, compliance requirements, etc. By further example, the expected outcomes and the realized outcomes are evaluated based on an observer's happiness or satisfaction. The observer may be a client, customer, beneficiary, recipient, auditor, consultant, or ratings professional. The happiness or satisfaction may have subjective factors or be reduced to objective factors, for example, with quantifiable metrics. By further example, the expected outcomes and the realized outcomes are evaluated based on time (e.g., time to completion, duration of project, time remaining before deadline, etc.). By further example, the expected outcomes and the realized outcomes are evaluated based on cost or expenditures. Cost and expenditures may be compared to a budget, funds available, or other quantifiable financial criteria.

According to some embodiments, one or more bases for determining or evaluating expected outcomes or realized outcomes are combined to generate feedback. For example, one or more of (1) quality, (2) satisfaction, (3) time, and (4) cost may be combined to produce a combined outcome or determine a feedback. Outcomes may be combined directly or by a weight function (weighted average, least root square, etc.), wherein some of a combination of factors have a relatively greater or lesser overall influence in determining a combined outcome or feedback. The weight function may be preprogrammed, user-defined, or based on previous feedback.

According to some embodiments, the expected outcomes or the realized outcomes apply to a single comprehensive project. According to some embodiments, the expected outcomes or the realized outcomes apply to components of a single comprehensive project, such that outcomes are evaluated prior to completion of a single project. For example, outcomes may be evaluated in parallel, such that multiple factors are applied prior to determining a feedback. By further example, outcomes may be evaluated in series, such that a first factor is applied prior to determining a feedback and prior to applying a second factor. According to some embodiments, any number of factors may be applied in series or in parallel.

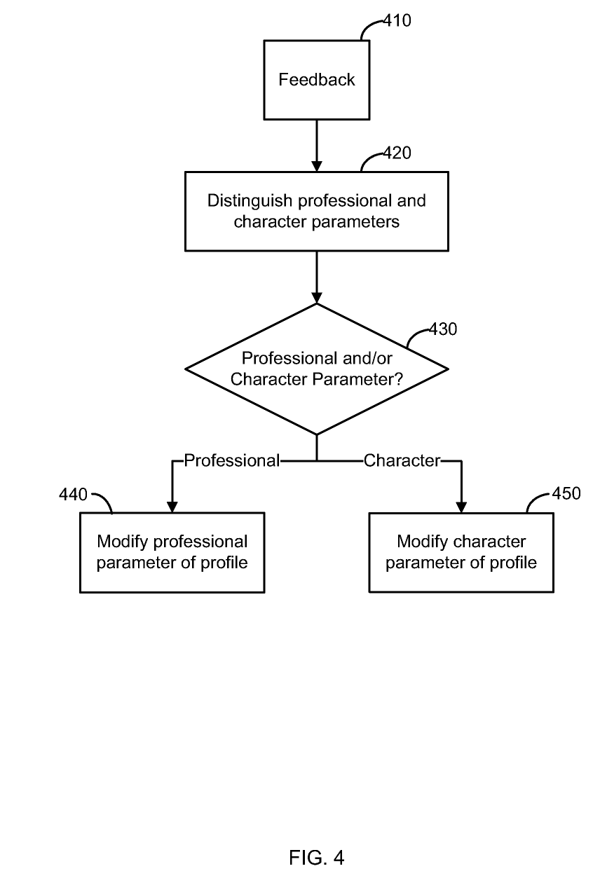

According to some embodiments, the knowledge database 160 is used to store rules relating to categorization of feedback, performance evaluations, and profiles. For example, as shown in FIG. 4, the first rules may include rules that determine whether a feedback relates to a professional parameter or a character parameter of the profile. In step 410, a feedback is received. In step 420, elements of the feedback are distinguished between professional and character parameters. A given feedback may contain one or both of at least one professional parameter and at least one character parameter. Rules for distinguishing between professional parameters and character parameters may be stored on the knowledge database 160 or on computing devices 110-1 to 110-3. One or more elements of the feedback may relate to a professional parameter. In step 430, if an element of the feedback relates to a professional parameter, then the professional parameter of the profile is modified in step 440. One or more elements of the feedback may relate to a character parameter. In step 430, if an element of the feedback relates to a character parameter, then the character parameter of the profile is modified in step 450. One or more elements of the feedback may relate to both a professional parameter and a character parameter. In step 430, if an element of the feedback relates to a professional parameter and a character parameter, then both the professional parameter and the character parameter of the profile are modified in steps 440 and 450.

As discussed above, the people database 150 is used to store profiles of individuals. The profile for each individual may include professional parameters, such as an employment history of the individual, a work position held by the individual, a type of work performed by the individual, a skill level of the individual, and an availability of the individual to work on a project. The type of work performed by the individual may include electrician, iron worker, plumber, cement mason, carpenter, etc. The skill level of the individual may include the education of the individual, years of experience of the individual, level of training of the individual, etc. The employment history of the individual may include previous projects on which the individual has worked, the time period that the individual worked on each project, the type of work the individual performed on each project, etc. The availability of the individual may indicate the time that the individual is available to work on a project.

The profile for each individual may include character parameters, such as reputation, trustworthiness, reliability, personality traits, adaptability, inter alia. Reputation may include results of reviews, evaluations, or other input by others. Trustworthiness may include a record of an individual's actions relative to a standard to be fulfilled. Reliability may include a record of an individual's produced output relative to expected output. Personality traits may include results of a personality assessment based on predetermined criteria of mental, emotional, social aptitude or ability. Adaptability may include capacity for identifying, demonstrating, or learning social behaviors.

The profile for each individual may also include an evaluation of the performance by the individual on any project, or portion thereof, completed by the individual. The evaluation of the performance by the individual on a particular project may be made by a manager supervising the individual on the project. For example, the manager may input a performance evaluation for the individual into the people database 150 via a computing device 110-1 to 110-3 at the project site. The evaluation may be based on the quality of work by the individual, the time it takes the individual to complete a task in relation to the expected time to complete the task, the cost for the individual to complete the task in relation to the expected cost for the task, incidences of disciplinary actions against the individual, ability of the individual to work with others, etc. The performance evaluation may also be based on the time it takes the individual to complete a portion of a task in relation to an expected time to complete the portion of the task. For example, the evaluation may be based on the time its takes the individual to complete 50% of the task in relation to an expected time to complete 50% of the task. Thus, the performance evaluation for the individual on a project may be updated while the individual is working on the project.

The performance evaluation for an individual may be in the form of a score on a predetermined scale. The performance evaluation for the individual on a particular project may be aggregated with performance evaluations for the individual on other similar projects to produce an overall performance evaluation for the individual. According to some embodiments, the project processor 115 may compute the overall performance evaluation for the individual by including only performance evaluations made within a certain time period (e.g., last two years) so that only recent performance evaluations are counted. In another embodiment, the project processor 115 may compute the overall performance evaluation for the individual by weighting the past performance evaluations, in which more recent evaluations are weighted higher than older evaluations so that the overall performance evaluation is more heavily influenced by the individual's recent performances.

According to some embodiments, a resource database 165 is used to store profiles and other information relating to resources. Resources include persons, materials, and tools (e.g., equipment) available for or related to a project. The resource database 165 may contain information relating to each of a variety of resources, including availability, effectiveness, efficiency, cost, quantity, quality, requirements, compatibility, state of repair, and output of any given resource. Information relating to a resource may be stored in a profile for said resource, wherein the profile can be accessed by a project processor 115.

The profile for each resource may also include an evaluation by an individual on any project, or portion thereof, with which the resource was utilized. The evaluation of the performance may be made by a manager supervising use of the resource on the project. For example, the manager may input a performance evaluation for the resource into the resource database 165 via a computing device 110-1 to 110-3 at the project site. The evaluation may be based on the quality of work by the resource, the time it takes the resource to complete or aid in completion of a task in relation to the expected time to complete the task, the cost for the resource to complete or aid in completion of the task in relation to the expected cost for the task, problems arising during or due to use of the resource, compatibility of the resource with others elements (e.g., other resources) of the project, etc. The performance evaluation may also be based on the time it takes the resource to complete or aid in completion of a portion of a task in relation to an expected time to complete the portion of the task. For example, the evaluation may be based on the time its takes the resource to complete or aid in completion of 50% of the task in relation to an expected time to complete 50% of the task. Thus, the performance evaluation for the resource on a project may be updated while the resource is utilized for the project.

Each resource, or the profile thereof, may be evaluated based on one or more predetermined criteria, thresholds, scores, or weighted factors to determine whether the resource should be used in connection with a project. The performance evaluation for a resource may be in the form of a score on a predetermined scale. The performance evaluation for the resource on a particular project may be aggregated with performance evaluations for the resource on other similar projects to produce an overall performance evaluation for the resource. According to some embodiments, the project processor 115 may compute the overall performance evaluation for the resource by including only performance evaluations made within a certain time period (e.g., last two years) so that only recent performance evaluations are counted. In another embodiment, the project processor 115 may compute the overall performance evaluation for the resource by weighting the past performance evaluations, in which more recent evaluations are weighted higher than older evaluations so that the overall performance evaluation is more heavily influenced by the resource's recent performances.

According to embodiments, the resource database 165 may be stored within the people database 150. According to embodiments, the people database 150 may be stored within the resource database 165.

As discussed above, the project database 155 is used to store information about projects. The information for each project may include information on persons or other resources needed to complete the project. For example, the information for a project may be entered into the project 155 by a project planner via a computing device 110-1 to 110-3. In this example, the project planner may determine the persons needed to complete the project, and for each person, enter the type of work to be performed by the person, a required skill level of the person, and an amount of time for the person to perform on the project. The type of work to be performed by a person may include electrician, iron worker, plumber, cement mason, carpenter, etc. The skill level of the person may include desired education of the person, years of experience of the person, level of training of the person, etc. The amount of time for a person may include the estimated time that the person will be needed to work on the project. For example, if the type of worked performed by a person is needed for a certain task of a construction project, then the time that the person will be needed may be based on the estimated time that the task will need to be performed on the project.

The project database 155 may also store expected outcomes of the project, and realized outcomes of the project, after they are realized. The expected outcomes may include a schedule for the project including an estimated completion time for each task or milestone of the project, estimated delivery times of materials and/or equipment to the project site, estimated cost to complete a task, etc. Examples of different tasks or milestones for construction of a building may include laying a foundation, building a frame, installing electrical wiring in the building, installing drywall in the building, etc. An expected outcome of the project may be inputted to the project database 150 by a project planner via a computing device 110-1 to 110-3. An expected outcome may also be modified based on one or more realized outcomes of the project. For example, the expected outcome (e.g., expected completion time) for a task of the project may be modified based on the realized outcome for an earlier task of the project, as discussed further below.

The realized outcomes may include the actual completion time for each task or milestone of the project, the actual delivery times of materials and/or equipment to the project site, the actual cost of a task of the project, etc. For example, an on-site manager may enter the realized outcomes to the project database 155 via a computing device 110-1 to 110-3 as each outcome is realized. In this example, the computing device 110-1 to 110-3 may be a portable computing device (e.g., PDA, smart phone, etc.) with wireless connectivity to the network 105.

As discussed above, the project processor 115 identifies individuals to work on a project by comparing the profiles of the individuals in the people database 150 with the information for persons needed on the project in the project database 155. For example, the project processor 115 may match an individual in the people database to a person needed on a project when the type of work and/or skill level of the individual in the people database 150 matches the type of work and/or skill level of a person needed on the project in the project database 155. When more than one individual matches the type of work and/or skill level of the person needed on the project, the project processor 155 may select the individual with the highest performance evaluation and/or longest work history in the people database 150. As another example, the project processor 115 may match an individual to a person needed on a project when the availability of the individual in the people database 150 matches the time that the person will be needed to work on the project in the project database 155.

The project processor 115 may also modify the information for a person needed on a project in the project database 155 based on one or more of the realized outcomes. For example, if one task (e.g., build a frame) of the project is completed behind schedule, then the project processor 115 may push back the time that a person in the project database 155 will be needed to perform a subsequent task (e.g., install electrical wiring) of the project. In this example, the project processor 115 may compare the availability of the individual initially matched to the person in the project database 155 with the new time to determine whether that individual will still be available to work on the project at the new time. If the individual is no longer available, then the project processor 115 may search the people database 150 for another individual that matches the person based on the new time. In this example, the project processor 115 may also modify the availability of the individual in the people database accordingly so that the individual is not available to work on another project during the new time.

As discussed above, the project processor 115 may be further configured to modify the performance evaluation for an individual based on feedback from at least one of the realized outcomes in relation to at least one of the expected outcomes. For example, if the actual completion time for a task by the individual on a project meets the expected completion time for the task, then the overall performance evaluation for the individual may be modified accordingly. For example, the individual may be given a high score for meeting the expected completion time and this high score may be aggregated with other scores that the individual received for other projects to obtain the overall performance evaluation. If, on the other hand, the actual completion time for the task by the individual goes over the expected completion time for the task, then the overall performance evaluation for the individual may be lowered accordingly. The amount that the performance evaluation is lowered may be based on the amount by which the individual goes over the expected completion time. In another example, if the actual cost to complete a task is within the expected cost for the task, then the overall performance evaluation for the individual may be modified accordingly. For example, the individual may be given a high score for completing the task within the expected cost for the task and this high score may be aggregated with other scores that the individual received for other projects to obtain the overall performance evaluation. If, on the other hand, the actual completion cost to complete the task exceeds the expected cost for the task, then the overall performance evaluation for the individual may be lowered accordingly. This may occur, for example, when the individual overbills for the task.

The project processor 115 may be configured to modify an expected outcome based on feedback from at least one of the profiles. For example, if the skill level of an individual working on a task increases while the individual is working on the task, then the expected completion time for the task may be reduced since a person with a higher skill level may be expected to complete the task faster. In this example, the skill level of the individual may increase, for example, if the individual completes a training program while working on the project. In another example, if a disciplinary action and/or an inability to work with others is entered into the profile for the individual in the people database 150 during the project, then the expected completion time for the task may be pushed back since a disciplinary action and/or an inability to work with others may reduce the likelihood that the task will be completed on time. In this example, the individual's performance may be evaluated based on the original unmodified expected completion time task. In another example, if the individual completes a portion (e.g., 50%) of a task ahead of the expected time to complete the portion of the task, then the performance evaluation of the individual may be increased accordingly, as discussed above. In this example, the expected time to complete the entire task may be pushed ahead based on the increase in the individual's performance evaluation since a higher performance evaluation may correlate with faster performance of the task.

The project processor 115 may be configured to modify at least one of the expected outcomes based on feedback from at least one of the realized outcomes. For example, if the actual completion time for a task goes over an expected completion time for the task, then the expected completion time for subsequent tasks that are dependent on the task may be modified accordingly. For example, if the actual completion time for electrical installation exceeds the expected completion time, then the expected completion time for drywall installation may also be pushed backed accordingly. In another example, if the actual time to complete a portion of the task (e.g., 50% of the task) goes over the expected time to complete the portion of the task, then the expected completion time for the entire task may be increased to take this into account.

According to some embodiments, the profile for each individual may include information relating to at least one access parameter. An access parameter may be based on, determined by, or affected by at least one of information in the profile, a performance evaluation, feedback, a realized outcome, or an expected outcome.

According to some embodiments, an access parameter may determine or affect at least one of other information in the profile, feedback, a realized outcome, or an expected outcome. For example, an access parameter associated with an individual's profile may determine whether the individual has access to a privilege. Access to a privilege may include security clearance, permission to take an action, permission to participate in a project, authority over at least an aspect of a project, and the like.

Access parameters for each individual may be entered into the profile. According to some embodiments, computing devices 110-1 to 110-3 or project processor 115 may be configured to modify at least one access parameter associated with a personal profile. Entry or modification of an access parameter may be based on other information in the profile, a performance evaluation, feedback, a realized outcome, or an expected outcome. For example, an access parameter may be based on at least one of a professional parameter and a character parameter.

As discussed above, the knowledge database 160 is used to store rules that direct the project processor 115 how to modify information in the databases 150, 155, 160, and 165 based on feedback. Thus, the modification of information in the databases 150, 155, 160, and 165 based on feedback may be rules-based.

According to some embodiments, the knowledge database 160 may include first rules that determine how the feedback from the at least one of the realized outcomes in relation to the at least one of the expected outcomes modifies the performance evaluation. For example, a rule may specify a score that an individual receives after completing a task based on the actual completion time for the task in relation to the expected completion time for the task. For example, the rule may specify that the individual receive a high score when the actual completion time is within the expected completion time and a low score when the actual completion time runs over the expected completion time. In this example, the rule may be in the form of an algorithm with the actual completion time for the task and the expected completion for the task as the inputs and the score as the output. The score that the individual receives for the task may be aggregated with scores that the individual received for similar tasks on previous projects to obtain an overall score for the individual, as discussed above. In another example, a rule may specify a score that an individual receives after completing a task based on the actual cost to complete the task in relation to the expected cost for the task. For example, the rule may specify that the individual receive a high score when the actual cost is within the expected cost for the task and a low score when the actual cost exceeds the expected cost.

According to some embodiments, the knowledge database 160 may include second rules that determine how the feedback from the at least one of the profiles modifies the at least one of the expected outcomes. For example, a rule may specify that the expected completion time for a task is pushed back when a disciplinary action is reported against the individual in the people database 150. In another example, a rule may specify that the expected completion time for a task is pushed back when the individual's performance evaluation for the project after completing a portion of the task is low (e.g., below a performance threshold), and that the expected completion time for the task is pushed ahead or unchanged when the individual's performance evaluation for the project after completing the portion of the task is high (e.g., above a performance threshold).

According to some embodiments, the knowledge database 160 may include third rules that determine how the feedback from the at least one of the realized outcomes modifies the at least one of the expected outcomes. For example, a rule may specify by how much an expected completion time for a task is pushed back when the actual completion time for a previous task is behind schedule. In another example, a rule may specify that the expected completion time for a task is pushed back when the actual delivery time of materials for the task at the project site is behind schedule. In this example, the rule may specify that the expected completion time for the task is pushed back by the same or similar amount by which the actual delivery time is behind schedule. Also, in this example, the expected completion time of a subsequent task that is dependent on the current task may also be pushed back by a similar amount. In yet another example, a rule may specify that the expected completion time for a task is pushed back when the actual time to complete a portion of the task exceeds the expected time to complete that portion of the task.

According to some embodiments, the project processor 115 may modify one of the first, second and third rules based on at least one of the realized outcomes. For example, a realized outcome may comprise environmental and/or economic conditions that negatively impact the project. In this example, the project processor 115 may modify one of the first, second and third rules based on the realized outcome. For example, a rule may specify that an individual receive a low performance evaluation if the actual time to complete a task runs over the expected time to complete the task. In this example, the project processor 115 may modify this rule based on a realized outcome (e.g., environmental condition) that negatively impacts the ability of the individual to complete the task on time so that the individual does not receive a low performance if the actual time to complete the task runs over the expected time. In another example, a rule may specify that an individual receive a low performance evaluation if the actual cost to complete a task exceeds the expected cost. In this example, the project processor 115 may modify this rule based on a realized outcome (e.g., economic condition) that negatively impacts the ability of the individual to complete the task within the expected cost so that the individual does not receive a low performance if the actual cost exceeds the expected cost. For example, the realized outcome may be based on actual cost of materials and/or equipments used by the individual to perform the task.

The realized outcome may be inputted into the project database 155 by a manager via a computing device 110-1 to 110-3 and/or automatically inputted into the project database 155 by a computing device 110-1 to 110-3. For example, a computing device 110-1 to 110-3 may, at the time a task is being performed, automatically track the prices for materials and/or equipment from a market database related to the task and input the cost for the materials and/or equipment into the project database 155 as one of the realized outcomes for the project. In another example, a computing device 110-1 to 110-3 may, at the time a task is being performed, automatically track environmental conditions (e.g., weather) at the project site from a database and input the environmental condition into the project database 155 as one of the realized outcomes for the project.

According to some embodiments, the project processor 115 may modify one of the first, second and third rules based on a relationship between at least one of the realized outcomes and at least one of the expected outcomes. For example, the relationship between a realized outcome and an expected outcome may be negatively impacted by an external condition, e.g., environmental and/or economic condition. For example, the external condition may be estimated to cause an actual completion time for a task to exceed an expected completion time by a certain amount (e.g., 2 days over the expected completion time), and a rule may specify that an individual receive a low performance evaluation if the actual time to complete a task runs over the expected time to complete the task. In this example, the project processor 115 may modify this rule so that the individual does not receive a low performance if the actual time to complete the task runs over the expected time within the certain amount (e.g., 2 days over the completion time). The external condition may include bad weather, a road block to the project site, etc.

In another example, the external condition (e.g., market conditions) may be estimated to cause an actual cost for a task to exceed an expected cost by a certain amount (e.g., 25% over expected cost), and a rule may specify that an individual receive a low performance evaluation if the actual cost to complete a task exceeds the expected cost to complete the task. In this example, the project processor 115 may modify this rule so that the individual does not receive a low performance if the actual cost exceeds the expected cost within the certain amount (e.g., 25% over expected cost).

According to some embodiments, steps disclosed herein may be performed by or on one of, a plurality of, or a combination of computing devices 110-1 to 110-3, project processor 115, or another device. According to some embodiments, all steps disclosed herein may be performed by or on a single device. According to some embodiments, separate steps disclosed herein may be performed by or on separate devices. Data, such as contents of people database 150, project database 155, or knowledge database 160, that enables or enhances performance of steps disclosed herein may be stored, copied to, or synchronized with one or more of computing devices 110-1 to 110-3.

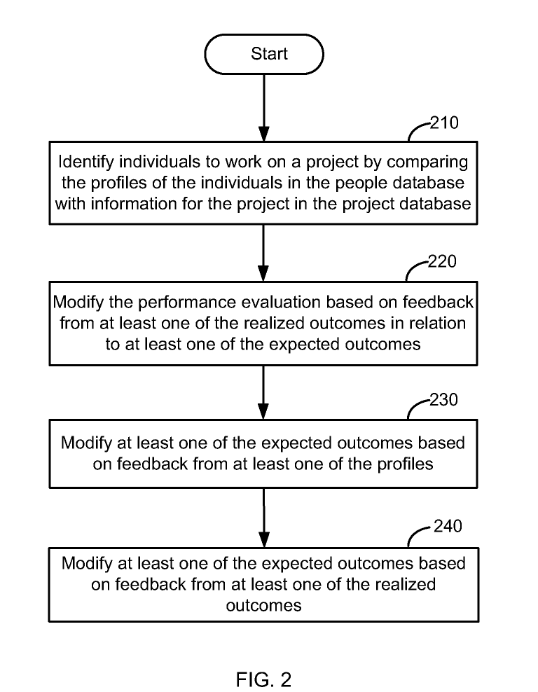

FIG. 2 is a flowchart of a method for managing a project in a project management system according to some embodiments of the subject technology. The project management system comprises (i) a people database storing profiles of individuals, wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project, and (ii) a project database storing information about projects, wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project. The method may comprise some or all of the steps discussed below.

In step 210, individuals to work on a project are identified by comparing the profiles of the individuals stored in the people database with the information for the project stored in the project database. In step 220, the performance evaluation is modified based on feedback from at least one of the realized outcomes in relation to at least one of the expected outcomes. In step 230, at least one of the expected outcomes is modified based on feedback from at least one of the profiles. In step 240, at least one of the expected outcomes is modified based on feedback from at least one of the realized outcomes.

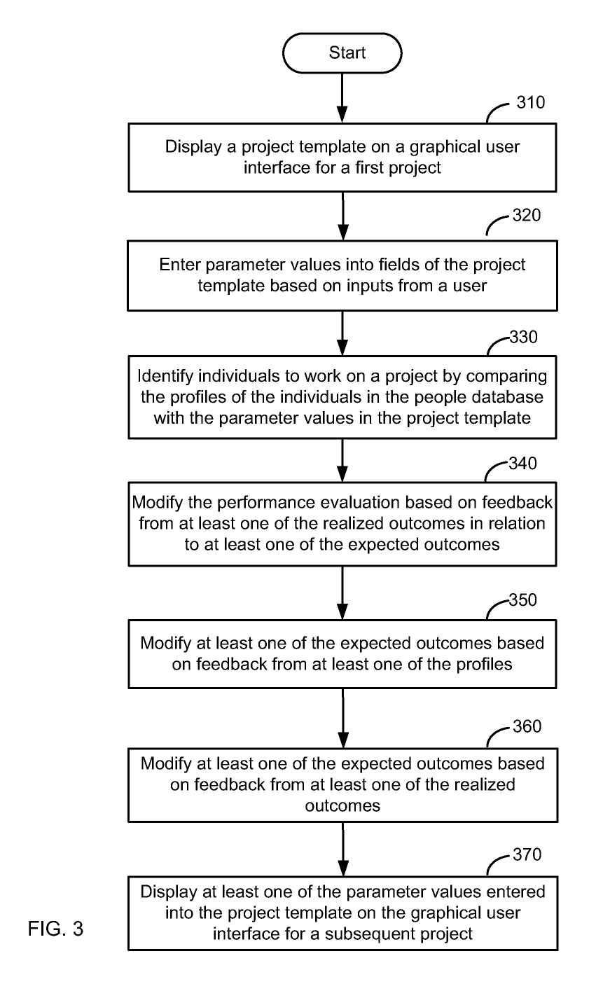

FIG. 3 is a flowchart of a method for managing a project in a project management system according to some embodiments of the subject technology. The project management system comprises (i) a people database storing profiles of individuals, wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project, and (ii) a project database storing information about projects, wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project. The method may comprise some or all of the steps discussed below.

In step 310, a project template is displayed on a graphical user interface for a first project. In step 320, parameter values are entered into fields of the project template based on inputs from a user. The parameter values include (a) information on at least one person needed to complete the first project, (b) expected outcomes of the first project, and (c) a cost of at least a portion of the first project. In step 330, individuals to work on a project are identified by comparing the profiles of the individuals stored in the people database with the parameter values in the project template. In step 340, the performance evaluation is modified based on feedback from at least one of the realized outcomes in relation to at least one of the expected outcomes. In step 350, at least one of the expected outcomes is modified based on feedback from at least one of the profiles. In step 360, at least one of the expected outcomes is modified based on feedback from at least one of the realized outcomes. In step 370, at least one of the parameter values entered into the project template is displayed on the graphical user interface for a subsequent project.

It is to be understood that the term “modify” may involve changing a value (e.g., non-zero value) of a parameter to another value. For example, modifying an expected outcome (e.g., completion time of a task) may involve changing the completion time of the task from one date to another date.

The term “modify” may also involve setting an initial value of a parameter. For example, an expected completion time of a task (e.g., completion time of a structural frame) may be left blank until a previous task is completed (e.g., completion time of the foundation). In this example, modifying the expected completion time of the task may involve setting an initial value (e.g., date) of the expected completion time of the task based on the actual completion time of the previous task.

The term “modify” may also involve changing a default value of a parameter to a non-default value. For example, an individual working on a project may initially be given a default performance evaluation value for a task (e.g., a value equal to an average of performance evaluation values for other individuals who performed a similar task). In this example, the individual's performance evaluation value may be changed from the default value (e.g., average value) to a non-default value based on the actual time for the individual to complete a portion of the task relative to an expected time to complete the portion of the task. For example, if the individual's actual completion time is ahead of the expected completion time, then the individual's performance evaluation value may be changed to a value greater than the default value (e.g., average value).

Further, it is to be understood that a realized outcome may be an outcome for an entire task or a portion thereof (e.g., subtask). For example, a realized outcome for a task may be an actual completion time for an entire task (e.g., drywall installation of an entire building) or an actual completion time for a pre-defined portion of the task (e.g., drywall installation on half the floors of the building). In another example, a realized outcome for a task may be an actual completion time for a subtask (e.g., mixing cement) of a task (e.g., constructing a foundation). A subtask of a task may refer to one or more steps of a sequence of steps needed to complete the task. Similarly, an expected outcome may be an expected outcome for an entire task or a portion thereof (e.g., subtask).

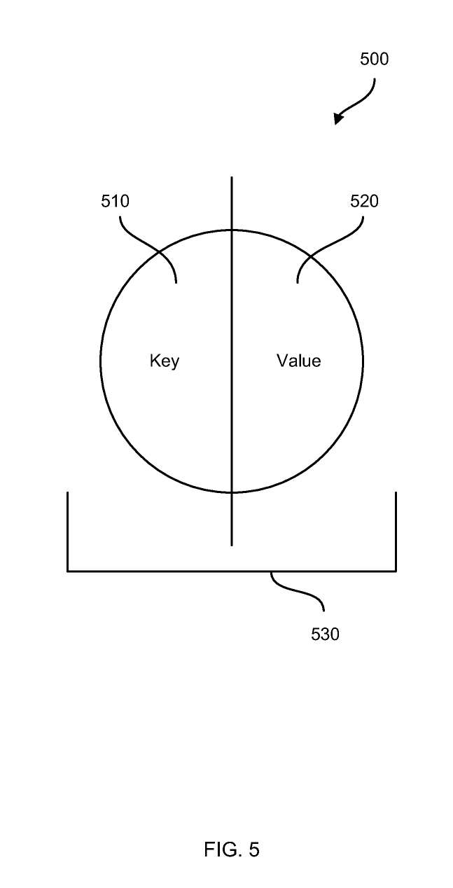

According to some embodiments, at least one of the databases 150, 155, 160, and 165 are managed via object-oriented programming. For example, at least one of the databases 150, 155, 160, and 165 may use objects, i.e. data structures, to organize data fields and manage interactions. According to some embodiments, as shown in FIG. 5, at least one of the databases 150, 155, 160, and 165 includes a data structure 500 that incorporates an associative array. The associative array of data structure 500 may be a map or dictionary comprising a collection of (key, value) pairs. Each cell 530 may have pairs with constituent members key 510 and value 520, as shown in FIG. 5. Key 510 may be expressible as a noun, and value 520 may be expressible as a verb, wherein the collection of (key, value) pairs provides data for one or more of the databases 150, 155, 160, and 165. According to some embodiments, each possible key appears at most once in the collection. Operations for data structure 500 include the addition of pairs to the collection, the removal of pairs from the collection, the modification of the values of existing pairs, and the lookup of a value associated with a particular key. According to some embodiments, data structure 500 may include a hash table, directly addressed arrays, binary search trees, an indexing service, etc.

In one aspect, the project database 155 may include a blank project template that a project planner may fill in with data for a project. For example, the project template may include blank fields within which the user can enter parameter values for the project including labor costs, material costs, different tasks or phases of the project, workers needed for the project, expected outcomes (e.g., expected completion time for a task) for the project, etc. In one aspect, the project planner may have the option of adding additional fields to or deleting selected fields from the project template. For example, the template may initially have fields for entering data for a preset number of workers, and the project planner may add additional fields to the template to enter data for additional workers that may be needed for a particular project. In another example, the project planner may delete a field that is not needed for a particular project or leave the field blank.

After the project planner fills in the project template with data for a particular project, the filled-in project template may be used for subsequent projects. For example, when the same or different project planner is planning a subsequent project, the project planner may use a project template that has already been filled in with data for a previous project as a starting point. In this example, the project planner may modify parameter values that are different between the two projects while leaving the parameter values that are the same for the two projects unchanged. An advantage of this aspect is that once a project template has been filled in with data for an initial project, the filled-in project template may be used for a subsequent project to reduce the amount of time needed to enter parameter values for the subsequent project. The filled-in project template may be stored in the project database 155 for use in future projects.

In one aspect, one or more of the parameter values entered into the project template for a particular project may be modified during the course of the project. For example, an expected outcome (e.g., expected completion time for a particular task) for the project may be modified based on a realized outcome (e.g., actual completion time for a previous task) for the project. In this aspect, when a parameter value is modified during the course of the project, the modified parameter value may be used for a subsequent project instead of the parameter value initially entered into the project template. Thus, one or more of the parameter values that are initially entered into the project template for a project may be updated during the course of the project, and the one or more updated values may be used in the template for a subsequent project instead of the corresponding initial values.

In one aspect, when a parameter value is modified (e.g., in response to a realized outcome), the project planner may have the option of indicating whether the modified parameter value or the parameter value initialed entered into the project template is used for a subsequent project. For example, if the parameter value is modified in response to an actual outcome that is not likely to occur during a subsequent project (e.g., unusually bad whether conditions), then the project planner may keep the initial parameter value in the template as a starting point for the subsequent project. On the other hand, if the initial parameter value is modified because the project planner's initial estimate for the value turns out to be unrealistic, then the project planner may indicate that the modified parameter value is to be used as the starting point for the subsequent project. In this example, if other parameter values are dependent on the parameter value being modified and are themselves modified as a result of the modification to the parameter value, then the resulting modifications to the other parameter values may also be used for the subsequent project. For example, the parameter value that is modified may be an expected completion time for a first task, and the other parameter value may be expected completion times for subsequent tasks, which are dependent on the completion time for the first task.

In another aspect, when the project planner enters data into a project template, the project planner may specify a project type (e.g., school) for the project template. In this aspect, the project processor 120 may store a plurality of previously filled-in project templates for different project types in the project database 155. When a project planner plans a subsequent project, the project planner may enter a project type (e.g., school) for the subsequent project. In this example, the project processor 120 may retrieve a previously filled-in project template for the same project type from the project database 155 as a starting point for the subsequent project.

If a previously filled-in project template is not available for a particular project type requested by a project planner, then the project processor 120 may display project types having previously filled-in project templates that are available. The project planner may select a previously filled-in project template for a project type that is closest to the project type (e.g., school) being requested by the project planner. Alternatively, the project planner may request a blank project template to fill in.

There may be many other ways to implement the subject technology. Various functions and elements described herein may be partitioned differently from those shown without departing from the spirit and scope of the inventions. Various modifications to these embodiments will be readily apparent to those skilled in the art, and generic principles defined herein may be applied to other embodiments. Thus, many changes and modifications may be made to the inventions, by one having ordinary skill in the art, without departing from the spirit and scope of the inventions.

A reference to an element in the singular is not intended to mean “one and only one” unless specifically stated, but rather “one or more.” The term “some” refers to one or more. Underlined and/or italicized headings and subheadings are used for convenience only, do not limit the inventions, and are not referred to in connection with the interpretation of the description of the inventions. All structural and functional equivalents to the elements of the various embodiments described throughout this disclosure that are known or later come to be known to those of ordinary skill in the art are expressly incorporated herein by reference and intended to be encompassed by the inventions. Moreover, nothing disclosed herein is intended to be dedicated to the public regardless of whether such disclosure is explicitly recited in the above description.

What is claimed is:

1. A project management system comprising:
(i) a people database storing profiles of individuals, wherein the profile for each individual comprises indicators for:
an employment history of the individual;
a work position held by the individual;
a type of work performed by the individual;
a skill level of the individual;
an evaluation of performance by the individual on any project, or portion thereof, completed by the individual; and
an availability of the individual for a project;
(ii) a project database storing information about projects, wherein the information for each project comprises indicators for:
(a) information on persons needed to complete the project, wherein the information on each person includes at least one of:
a type of work to be performed by the person;
a required skill level of the person; and
an amount of time for the person to perform on the project;
(b) expected outcomes of the project;
(c) realized outcomes of the project, after they are realized; and
(d) a cost of at least a portion of the project;
(iii) a project processor configured to:
identify individuals to work on a project by comparing the profiles of the individuals stored in the people database with the information for the project stored in the project database;
modify the performance evaluation based on feedback from at least one of the realized outcomes in relation to at least one of the expected outcomes;
modify at least one of the expected outcomes based on feedback from at least one of the profiles; and
modify at least one of the expected outcomes based on feedback from at least one of the realized outcomes.

2. The system of claim 1, further comprising a knowledge database having:
(a) first rules that determine how the feedback from the at least one of the realized outcomes in relation to the at least one of the expected outcomes modifies the performance evaluation;
(b) second rules that determine how the feedback from the at least one of the profiles modifies the at least one of the expected outcomes; and
(c) third rules that determine how the feedback from the at least one of the realized outcomes modifies the at least one of the expected outcomes.

3. The system of claim 2, wherein feedback based on at least one of the realized outcomes modifies at least one of the first rules, the second rules, and the third rules.

4. The system of claim 2, wherein feedback based on a relation between at least one of the realized outcomes and at least one of the expected outcomes modifies at least one of the first rules, the second rules, and the third rules.

5. The system of claim 1, wherein at least one of the expected outcomes comprises a cost of at least a portion of the project.

6. The system of claim 1, wherein at least one of the expected outcomes comprises a time to completion of at least a portion of the project.

7. The system of claim 2, wherein the at least one of the realized outcomes comprises an actual time to completion of a portion of a project and the at least one of the expected outcomes comprises an expected time to completion of the portion of the project.

8. The system of claim 7, wherein the first rules comprises a performance rule that increases a performance evaluation value of an individual when the actual time to completion occurs before the expected time to completion, and decreases the performance evaluation value of the individual when the actual time to completion occurs after the expected time to completion.

9. The system of claim 8, wherein the performance rule is modified based on at least one of the realized outcomes comprising at least one of an environmental and an economic condition that negatively impacts an ability of the individual to complete the portion of the task.

10. The system of claim 9, wherein the project processor is configured to automatically track the at least of the environmental and the economic condition.

11. The system of claim 2, wherein the at least one of the realized outcomes comprises an actual cost to complete a portion of a project and the at least one of the expected outcomes comprises an expected cost to complete the portion of the project.

12. The system of claim 11, wherein the first rules comprise a performance rule that increases a performance evaluation value of an individual when the actual cost is below the expected cost, and decreases the performance evaluation value of the individual when the actual cost exceeds the expected cost.

13. The system of claim 12, wherein the performance rule is modified based on at least one of the realized outcomes comprising an environmental or economic condition that negatively impacts an ability of the individual to complete the portion of the task.

14. The system of claim 13, wherein the project processor is configured to automatically track the environmental or economic condition.

15. The system of claim 2, wherein the second rules comprise an expected outcome rule that increases an expected time to completion or an expected cost of a portion of a project when a performance evaluation value of an individual is decreased.

16. The system of claim 2, wherein the third rules comprise an expected outcome rule that increases an expected time to completion of a task of a project when a realized time to completion of a previous task of the project exceeds an expected time to completion of the previous task.

17. The system of claim 1, wherein the profile for each individual further comprises indicators for at least one professional parameter and indicators for at least one character parameter.

18. The system of claim 1, wherein the information for each project further comprises indicators for at least one professional criterion and indicators for at least one character criterion.

19. A method of managing a project in a project management system, the project management system comprising (i) a people database storing profiles of individuals, wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project, and (ii) a project database storing information about projects, wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project, the method comprising:
identifying individuals to work on a project by comparing the profiles of the individuals stored in the people database with the information for the project stored in the project database;
modifying a performance evaluation based on feedback from at least one of the realized outcomes in relation to at least one of the expected outcomes;
modifying at least one of the expected outcomes based on feedback from at least one of the profiles; and
modifying at least one of the expected outcomes based on feedback from at least one of the realized outcomes.

20. The method of claim 19, further comprising:
displaying a project template on a graphical user interface for the first project;
entering parameter values into fields of the project template based on inputs from a user, the parameter values including:
(a) information on at least one person needed to complete the first project;
(b) expected outcomes of the first project; and
(c) a cost of at least a portion of the first project; and
displaying at least one of the parameter values entered into the project template on the graphical user interface for a subsequent project.

21. The method of claim 19, wherein identifying individuals to work on a project is performed by comparing at least one professional parameter of the individuals stored in the people database with at least one professional criterion for the project stored in the project database.

22. The method of claim 19, wherein identifying individuals to work on a project is performed by comparing at least one character parameter of the individuals stored in the people database with at least one character criterion for the project stored in the project database.

23. The method of claim 19, further comprising:
(a) modifying, by a processor, the performance evaluation based on first rules and the feedback from the at least one of the realized outcomes in relation to the at least one of the expected outcomes;
(b) modifying, by a processor, the at least one of the expected outcomes based on second rules and the feedback from the at least one of the profiles; and
(c) modifying, by a processor, the at least one of the expected outcomes based on third rules and the feedback from the at least one of the realized outcomes.

24. A method of managing a project in a project management system, comprising:
identifying, by a processor, individuals to work on a project by comparing profiles of individuals stored in a people database with information for projects stored in a project database; wherein the information for each project comprises indicators for (a) information on persons needed to complete the project, wherein the information on each person includes at least one of: a type of work to be performed by the person, a required skill level of the person, and an amount of time for the person to perform on the project, (b) expected outcomes of the project, (c) realized outcomes of the project, after they are realized, and (d) a cost of at least a portion of the project;
modifying, by a processor, a performance evaluation based on feedback from at least one of the realized outcomes in relation to at least one of the expected outcomes;
modifying, by a processor, at least one of the expected outcomes based on feedback from at least one of the profiles; and
modifying, by a processor, at least one of the expected outcomes based on feedback from at least one of the realized outcomes;
wherein the profile for each individual comprises indicators for: an employment history of the individual, a work position held by the individual, a type of work performed by the individual, a skill level of the individual, an evaluation of performance by the individual on any project, or portion thereof, completed by the individual, and an availability of the individual for a project.

25. The method of claim 24, further comprising:
displaying a project template on a graphical user interface for the first project;
entering parameter values into fields of the project template based on inputs from a user, the parameter values including:
(a) information on at least one person needed to complete the first project;
(b) expected outcomes of the first project; and
(c) a cost of at least a portion of the first project; and
displaying at least one of the parameter values entered into the project template on the graphical user interface for a subsequent project.

26. The method of claim 24, wherein identifying individuals to work on a project is performed by comparing at least one professional parameter of the individuals stored in the people database with at least one professional criterion for the project stored in the project database.

27. The method of claim 24, wherein identifying individuals to work on a project is performed by comparing at least one character parameter of the individuals stored in the people database with at least one character criterion for the project stored in the project database.

28. The method of claim 24, further comprising:
(a) modifying, by a processor, the performance evaluation based on first rules and the feedback from the at least one of the realized outcomes in relation to the at least one of the expected outcomes;
(b) modifying, by a processor, the at least one of the expected outcomes based on second rules and the feedback from the at least one of the profiles; and
(c) modifying, by a processor, the at least one of the expected outcomes based on third rules and the feedback from the at least one of the realized outcomes.
